(19) United States
(12) Patent Application Publication
(10) Pub. No.: US 2026/0121286 A1
(43) Pub. Date: Apr. 30, 2026

(54) ANTENNA RADOME, BASE STATION ANTENNA, PIM GUARD ASSEMBLY AND METHODS OF MAKING SAME

(71) Applicant: Outdoor Wireless Networks LLC, Richardson, TX (US)

(72) Inventors: Shanguang Zhang, Suzhou (CN); Dongmin Wang, Suzhou (CN); Rongrong Zhang, Suzhou (CN); Jianguo Wu, Suzhou (CN); PuLiang Tang, Suzhou (CN)

(21) Appl. No.: 19/363,955

(22) Filed: Oct. 21, 2025

(30) Foreign Application Priority Data
Oct. 29, 2024 (CN) 2024115240660

(51) Int. Cl. H01Q 1/42; B32B 1/08; B32B 5/02; B32B 15/08; B32B 15/20; B32B 27/20; H01Q 1/24; H01Q 15/00

(52) U.S. Cl. CPC H01Q 1/421; B32B 1/08; B32B 5/024; B32B 15/08; B32B 15/20; B32B 27/20; H01Q 1/246; H01Q 15/0013; B32B 2262/101; B32B 2311/24; B32B 2457/00

(57) ABSTRACT

An antenna radome comprises an elongated body shape that extends in a longitudinal direction and comprises an interior space, at least a portion of the body is integrated with a PIM guard structure or FSS structure inside.

### CROSS-REFERENCE TO RELATED APPLICATION

The present application claims priority to Chinese Patent Application No. 202411524066.0, filed Oct. 29, 2024, the entire content of which is incorporated herein by reference as if set forth fully herein.

### FIELD

The present disclosure generally relates to the technical field of wireless communication. More particularly, the present disclosure relates to an antenna radome, a base station antenna comprising the antenna radome, a PIM guard assembly for an antenna radome, and methods of making the same.

### BACKGROUND

Cellular communication systems are well known in this field. In a cellular communication system, a geographic area is divided into a series of “cells” serviced by respective base stations. A base station may comprise one or more antennas that are configured to provide two-way radio frequency (“RF”) communications for mobile users within the cell served by the base station. In many cases, each cell is divided into “sectors”. In a common configuration, a hexagonal cell is divided into three 120° sectors in the azimuth plane, and each sector is serviced by one or more base station antennas.

A base station antenna typically comprises a reflector, a radiating element, an antenna radome, and an associated circuit or electrical device (e.g., a feed network), etc. The radiating element may be mounted on one side (e.g., the front side) of the reflector. The antenna radome is configured to at least cover the reflector and the radiating element. Typically, the base station antenna is mounted on a tower or other raised structure, and a radiation pattern generated by the base station antenna (also referred to herein as an “antenna beam”) is directed outwardly.

In a cellular communication system, passive intermodulation (PIM) distortion, which refers to noise signals that can be generated in wireless communication systems when two or more RF signals encounter non-linear electrical junctions or materials along an RF transmission path. Such non-linearities may act like a mixer, causing the RF signals to generate new RF signals at mathematical combinations of the original RF signals. These newly generated RF signals are referred to as “inter-modulation products.” The newly generated RF signals may fall within the bandwidth of the “normal” RF signals that are transmitted and received by the wireless communication system. This may occur, for example, when RF signals transmitted through a device (e.g., a base station antenna) generate inter-modulation products that fall in the same bandwidth of signals that are received through the same device. If this occurs, the noise level experienced by the existing RF signals in the receiver bandwidth is increased. When the noise level is increased, it may be necessary to reduce the data rate and/or the quality of service. PIM distortion can be an important interconnection quality characteristic, as PIM distortion generated by a single low quality interconnection may degrade the electrical performance of the entire RF communications system.

The above-described inter-modulation products arise because non-linear systems generate harmonics in response to sinusoidal inputs. For example, when a signal having a first frequency Sn is input to a non-linear system, then the resulting output signal will include signals at integer multiples of the input frequency. When two or more signals having different frequencies are input to a non-linear system, inter-modulation products arise. For example, consider a composite input signal x(t) to a non-linear system that includes signals at three different frequencies:

$$x ( t ) = {A}_{1} sin ( 2 π {f}_{1} t + {φ}_{1} ) + {A}_{2} sin ( 2 π {f}_{2} t + {φ}_{2} ) + {A}_{3} sin ( 2 π {f}_{3} t + {φ}_{3} ) \qquad ( 1 )$$

In Equation (1) above, Aᵢ and φᵢ (i refers to 1, 2 and 3) are the amplitudes and phases of the signals at the three different frequencies f₁, f₂, f₃. These signals are passed through a non-linearity. The resulting output signal will include components at the frequencies f₁, f₂, f₃ of the three input signals, which are referred to as the fundamental components, as well as linear combinations of these fundamental components having the form:

$${k}_{1} {f}_{1} + {k}_{2} {f}_{2} + {k}_{3} {f}_{3} \qquad ( 2 )$$

where k₁, k₂, k₃ are arbitrary integers which can have positive or negative values. These components are the inter-modulation products and harmonics, and will have amplitudes and phases that are a function of the non-linearity and the composite input signal x(t).

The PIM sources (e.g., non-linear electrical junctions or materials along an RF transmission path) may be within the base station antenna or external thereto. As shown in FIG. 1, when the base station antenna 10 is mounted in the real environment, a number of PIM sources may be present in the environment that may deteriorate the PIM performance of the base station antenna 10. The PIM sources may comprise: PIM distortion generated in other antennas or RF equipment 11 in adjacent areas; immobilized cable connections, dirty contacts, or similar on the tower or other raised structure 12; materials of ducts or buildings 13; and the like.

FIG. 2 shows paths of PIM noise signals A and B when the base station antenna 10 is in the real environment, where A represents a PIM noise signal formed in response to energy emitted rearwardly by the radiating element 101 of the base station antenna 10 that is reflected back into the base station antenna after encountering a PIM source in the environment, and B represents a PIM noise signal that is generated within other equipment (e.g., another base station antenna) in the environment. In many cases, the PIM noise signals A and B may be the main factors that cause deterioration in the PIM performance of the base station antenna 10.

In order to reduce or block the transmission of the PIM noise signals A and B, as shown in FIG. 3, a common practice is to provide an additional metal plate 103 behind the reflector 102 of the base station antenna 10 (i.e.: the side away from the radiating element 101) for cutting off transmission paths of the PIM noise signals A and B. Adding metal plate 103, however, increases the weight and cost of the base station antenna 10 and may require changes in the layout of components within the base station antenna 10, which may require the redesign of the base station antenna 10. In addition, if the base station antenna 10 itself generates a large PIM noise signal, the metal plate 103 may also cause the secondary reflection of the PIM noise signal and thus amplify the effect of the internally-generated PIM noise signal.

In addition, with the development of the wireless communication technology, as shown in FIG. 4, an integrated base station antenna 20 that comprises a passive antenna module 21 and an active antenna module 22 has emerged. The passive antenna module 21 may comprise one or more passive radiating element arrays, which are configured to generate relatively static antenna beams, for example, are configured to be antenna beams that cover a 120-degree sector (in the azimuth plane) of the integrated base station antenna. The passive arrays may comprise arrays operating under a second generation (2G), third generation (3G), or fourth generation (4G) cellular standard. The active antenna module 22 may comprise one or more radiating element arrays operating under a fifth generation (or later) cellular standard, and these arrays generally have separate amplitude and phase control for a subset of the radiating elements therein and perform active beam forming.

In the integrated base station antenna 20, the active antenna module 22 is typically mounted at the back of the passive antenna module 21. In order to allow signals of the active antenna module 22 to be transmitted forwardly and to prevent the signals of the passive antenna module 21 from being transmitted backwardly, it is generally desirable to arrange a frequency selection surface (FSS) module 23 between the active antenna module 22 and the passive antenna module 21 (as shown in FIG. 5). The FSS module allows signals from the active antenna module 22 to pass through and is capable of reflecting signals from the passive antenna module 21 back to prevent signals of the passive antenna module 21 from being passed backwardly.

Currently, it is common for the FSS module 23 to be adhered to an inner surface of the back of the antenna radome of the passive antenna module 21 using adhesive tape, or adhered to matching layers inside the antenna radome of the passive antenna module 21. However, there are some shortcomings in these approaches. For example, additional labor and material costs are required to mount the FSS module; when the FSS module is large, it is difficult to adhere to the radome or matching layers, and the FSS module may also have defects after it is mounted such as crumpling, flaking, or bubbling. In addition, the adhesiveness of the tape may decrease at low temperatures, so it is difficult to perform pasting operation at low temperature; and a short circuit may occur between the FSS module and the reflector or frame, thereby causing the loss of the PIM performance of the base station antenna 20.

### SUMMARY

In an aspect of the present disclosure, a method of making an antenna radome for a base station antenna is provided, wherein the antenna radome comprises a body generally in an elongated shape, the body extending in a longitudinal direction and comprising an interior space penetrating through the body along the longitudinal direction, wherein at least a portion of the body is integrated with a PIM guard structure or FSS structure, wherein the method comprises: providing an extrusion device, wherein the extrusion device comprises a forming mold having a cavity and a core positioned in the cavity of the forming mold, a gap exists between the forming mold and the core, and the gap has a cross-section substantially corresponding to a cross-section of the antenna radome to be formed; and supplying a first material and a second material to the extrusion device via different openings respectively to integrally form the antenna radome, wherein the first material is used for forming the antenna radome, and the second material is used for forming the PIM guard structure or FSS structure.

According to some embodiments of the present disclosure, the first material comprises glass fibers or plastic, and the second material comprises resin mixed with carbon particles, short carbon fibers, or metal powder.

According to some embodiments of the present disclosure, the first material is a glass fiber comprising two or more layers, and the second material comprises a metal film or an anti-static film, a metal grid structure, a printed circuit board, or a conductive fiber structure, wherein the method comprises: replacing an inner layer, an outer layer, or an intermediate layer of at least a portion of the glass fiber with the second material in the process of forming the antenna radome with the extrusion device.

According to some embodiments of the present disclosure, the first material is a glass fiber comprising two or more layers, and the second material comprises a metal film or an anti-static film, a metal grid structure, a printed circuit board, or a conductive fiber structure, wherein the method comprises: first replacing the intermediate layer, the inner layer, or the outer layer of the at least a portion of the glass fiber with the second material to form a composite layer before forming the antenna radome with the extrusion device, and then supplying the composite layer to the extrusion device.

According to some embodiments of the present disclosure, the step of replacing the intermediate layer, the inner layer, or the outer layer of the at least a portion of the glass fiber with the second material to form a composite layer comprises: manually laying up the second material.

In an aspect of the present disclosure, a method of making an antenna radome for a base station antenna is provided, wherein the antenna radome comprises a body generally in an elongated shape, the body extending in a longitudinal direction and comprising an interior space penetrating through the body along the longitudinal direction, wherein at least a portion of the body is integrated with a PIM guard structure or FSS structure, wherein the method comprises: supplying a first material to an extrusion device to extrude an initial body of the antenna radome, the initial body including a cavity structure formed of the first material; arranging a second material for forming the PIM guard structure or FSS structure within the cavity structure; and extruding the cavity structure inwardly from both sides of the cavity structure at a predetermined temperature and pressure, such that the first material and the second material are bound to one another.

According to some embodiments of the present disclosure, the first material comprises one of glass fibers and plastic, and the second material is selected from at least one of: a metal film or an anti-static film; a metal grid structure; a printed circuit board; a conductive fiber structure; and a PIM guard layer formed of carbon particles, short carbon fibers, or metal powder.

In an aspect of the present disclosure, a method of making an antenna radome for a base station antenna is provided, wherein the antenna radome comprises a body generally in an elongated shape, the body extending in a longitudinal direction and comprising an interior space penetrating through the body along the longitudinal direction, wherein at least a portion of the body is integrated with a PIM guard structure or FSS structure, wherein the method comprises: supplying a first material to an extrusion device to extrude a first portion of the antenna radome; forming a second portion comprising a PIM guard structure or FSS structure; and fixing the first portion and the second portion together.

According to some embodiments of the present disclosure, the first portion has a cross-section that is generally U-shaped.

According to some embodiments of the present disclosure, the first material is a glass fiber comprising two or more layers, the PIM guard structure or FSS structure is formed of a second material, and the second material comprises a metal film or an anti-static film, a metal grid structure, a printed circuit board, or a conductive fiber structure, wherein the second portion is formed by replacing an inner layer, an outer layer, or an intermediate layer of at least a portion of the glass fiber with the second material.

According to some embodiments of the present disclosure, the first material comprises one of glass fibers and plastic, the PIM guard structure or FSS structure is formed from a second material, the second material comprises resin mixed with carbon particles, short carbon fibers, or metal powder, and wherein the second portion is formed by extrusion of the second material.

According to some embodiments of the present disclosure, the first portion and the second portion are fixed together by bonding, mechanical connection, or conformal connection.

In an aspect of the present disclosure, an antenna radome for an base station antenna is provided, the antenna radome comprises a body generally in an elongated shape, the body extending in a longitudinal direction and comprising an interior space penetrating through the body along the longitudinal direction, wherein a PIM guard structure or FSS structure is integrated within at least a portion of a wall of the body, the PIM guard structure is configured to prevent the base station antenna from interfering by an external PIM source, and the FSS structure is configured to allow signals in a first frequency range to pass through and not allow signals in a second frequency range different from the first frequency range to pass through.

According to some embodiments of the present disclosure, the body of the antenna radome has a cross-section that is generally rectangular, elliptical, playground track-shaped, or circular in a plane perpendicular to the longitudinal direction, wherein the at least a portion of the body is a portion of the body that is behind a reflector of the base station antenna.

According to some embodiments of the present disclosure, the body of the antenna radome has a cross-section that is generally rectangular in a plane perpendicular to the longitudinal direction, wherein the body of the antenna radome comprises a front portion, a back portion opposite the front portion, and two side portions extending between the front portion and the back portion, and wherein the at least a portion of the body comprises the back portion.

According to some embodiments of the present disclosure, the at least a portion of the body further comprises corresponding sections of the two side portions that are adjacent the back portion, and wherein a length of each section does not exceed a distance from the back portion to a position where radiating elements of the base station antenna are positioned.

According to some embodiments of the present disclosure, the antenna radome has an integral structure.

According to some embodiments of the present disclosure, the antenna radome is formed by assembling a plurality of separate components, and wherein the PIM guard structure or FSS structure is integrated into one of the plurality of separate components.

According to some embodiments of the present disclosure, the PIM guard structure or FSS structure comprises one or more layers.

According to some embodiments of the present disclosure, the PIM guard structure is selected from at least one of: a metal film or an anti-static film; a metal grid structure; a printed circuit board; a conductive fiber structure; and a PIM guard layer formed of carbon particles, short carbon fibers, or metal powder.

According to some embodiments of the present disclosure, the metal film comprises an aluminum film or aluminum foil, the metal grid structure comprises a metal grill, a metal screen, or a metal perforated structure, the printed circuit board comprises a flexible circuit board, and the conductive fiber structure comprises a structure formed by weaving a carbon fiber material.

According to some embodiments of the present disclosure, the FSS structure is composed of a plurality of pattern cells arranged periodically along transverse and longitudinal directions of the antenna radome, and each pattern cell has a predetermined pattern and comprises a capacitive structure and an inductive structure.

According to some embodiments of the present disclosure, the antenna radome is manufactured by the method according to the present disclosure.

In an aspect of the present disclosure, a base station antenna is provided. The base station antenna comprises: an antenna radome according to the present disclosure; and a reflector and radiating elements positioned with the interior space of the antenna radome.

In an aspect of the present disclosure, a method of making a PIM guard assembly for an antenna radome is provided, wherein the PIM guard assembly comprises a first portion and a second portion, the first portion and the second portion extending along a longitudinal direction of the antenna radome by a length substantially equal to a length of the antenna radome, wherein the first portion and the second portion are connected to each other to cover a back of the antenna radome, wherein each of the first portion and the second portion is integrated with a PIM guard portion, and wherein the method comprises: providing an extrusion device, wherein the extrusion device comprises a forming mold having a cavity and a core positioned in the cavity of the forming mold, a gap exists between the forming mold and the core, and the gap has a cross-section substantially corresponding to a cross-section of the first portion and/or the second portion of the PIM guard assembly to be formed; and supplying a first material and a second material to the extrusion device in an appropriate arrangement to integrally extrude at least one of the first portion and the second portion of the PIM guard assembly, wherein the second material is used for forming the PIM guard portion.

In an aspect of the present disclosure, a method of making a PIM guard assembly for an antenna radome is provided, wherein the PIM guard assembly comprises a first portion and a second portion, the first portion and the second portion extending along a longitudinal direction of the antenna radome by a length substantially equal to a length of the antenna radome, wherein the first portion and the second portion are connected to each other to cover a back of the antenna radome, wherein each of the first portion and the second portion is integrated with a PIM guard portion, and wherein the method comprises: supplying a first material to an extrusion device to extrude an initial body of at least one of a first portion and a second portion of the PIM guard assembly, the initial body including a cavity structure formed of the first material; arranging a second material for forming the guard portion within the cavity structure; and extruding the cavity structure inwardly from both sides of the cavity structure at a predetermined temperature and pressure, such that the first material and the second material are bound to one another.

In an aspect of the present disclosure, a PIM guard assembly for an antenna radome is provided. The PIM guard assembly comprises a first portion and a second portion, the first portion and the second portion extending along a longitudinal direction of the antenna radome by a length substantially equal to a length of the antenna radome, wherein the first portion and the second portion are connected to each other to cover a back of the antenna radome, wherein each of the first portion and the second portion is integrated with a PIM guard portion, and wherein the PIM guard assembly is manufactured by the method according to the present disclosure.

According to some embodiments of the present disclosure, the first portion and the second portion of the PIM guard assembly are formed of the first material, and the PIM guard portion is formed of the second material, wherein the first material comprises one of glass fibers and plastic, and the second material is selected from at least one of: a metal film or an anti-static film; a metal grid structure; a printed circuit board; a conductive fiber structure; and a PIM guard layer formed of carbon particles, short carbon fibers, or metal powder.

According to some embodiments of the present disclosure, the first portion and the second portion of the PIM guard assembly are formed of carbon particles, short carbon fibers, or metal powder mixed in resin.

It should be noted that various aspects of the present disclosure described for one example may be comprised in other different examples, even though specific description is not made for the other different examples. In other words, all the examples and/or features of any example may be combined in any manner and/or combination, as long as they are not contradictory to each other.

### BRIEF DESCRIPTION OF THE DRAWING

FIG. 1 schematically illustrates a base station antenna mounted in a real environment and potential PIM sources that may influence it.

FIG. 2 schematically illustrates transmission paths of PIM noise signals that may degrade the performance of a base station antenna mounted in a real environment.

FIG. 3 schematically illustrates a conventional base station antenna that includes a metal plate that may block the paths of PIM noise signals.

FIG. 4 schematically illustrates a conventional integrated base station antenna comprising a passive antenna module and an active antenna module.

FIG. 5 schematically illustrates an FSS module that may be included in the integrated base station antenna shown in FIG. 4.

FIG. 6 schematically illustrates an antenna radome integrated with a PIM guard structure according to one example of the present disclosure.

FIG. 7a schematically illustrates an antenna radome integrated with an FSS structure according to one example of the present disclosure.

FIGS. 7b-7d schematically illustrate a variety of FSS structures according to different examples of the present disclosure.

FIG. 8a shows a schematic perspective view of an antenna radome according to one example of the present disclosure.

FIG. 8b is a schematic plan view of a cross-section of an antenna radome according to one example of the present disclosure in a plane perpendicular to an extension direction of the antenna radome.

FIG. 8c is a schematic plan view of a cross-section of an antenna radome according to another example of the present disclosure in a plane perpendicular to an extension direction of the antenna radome.

FIGS. 9a-9b schematically illustrate a method for making an antenna radome according to the present disclosure according to one example of the present disclosure.

FIGS. 10a-10d schematically illustrate steps of integrating a PIM guard structure or FSS structure in an antenna radome according to different examples of the present disclosure.

FIGS. 11a-11d schematically illustrate a method for making an antenna radome according to another example of the present disclosure.

FIGS. 12a-12c schematically illustrate a method for making an antenna radome according to yet another example of the present disclosure.

FIGS. 13a-13b schematically illustrate a PIM guard assembly used for an antenna radome in the prior art.

FIG. 14a schematically illustrates a cross-section of a PIM guard assembly according to one example of the present disclosure.

FIG. 14b is a partial enlarged view of a cross-section of the PIM guard assembly shown in FIG. 14a.

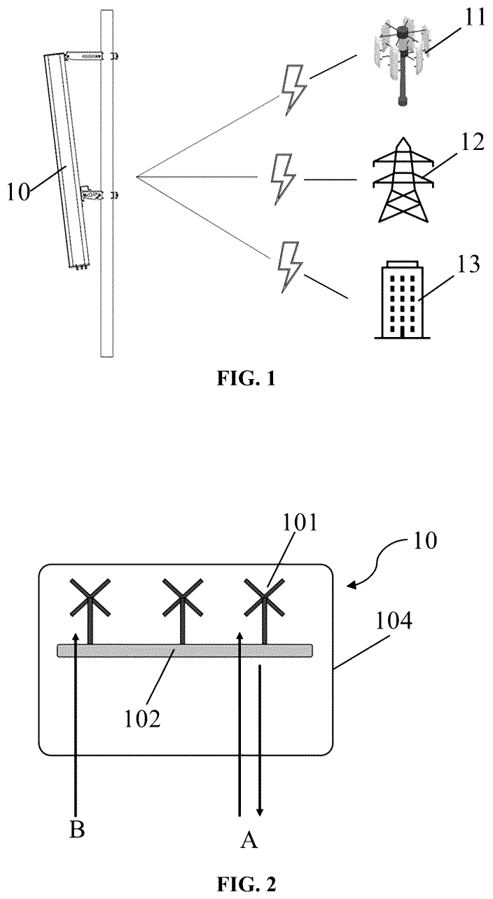

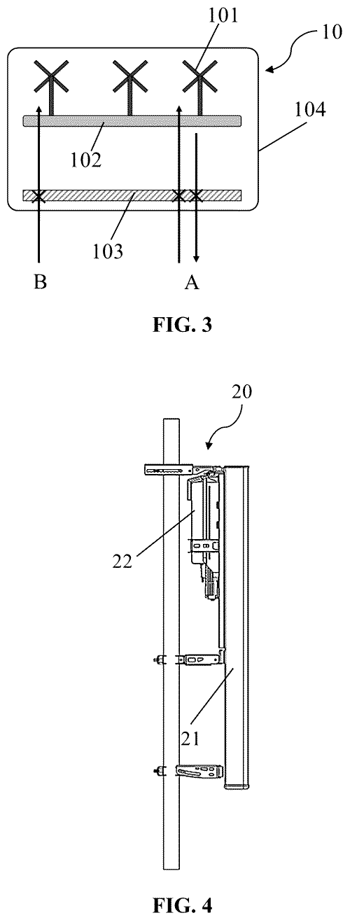

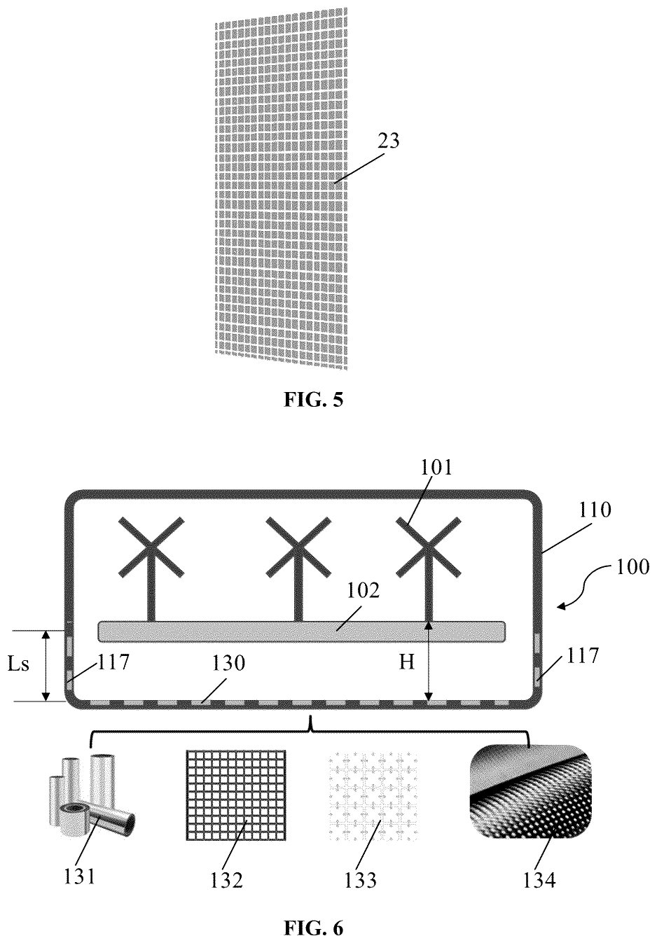

It should be understood that in all the attached drawings, the same symbols denote the same elements. In the attached drawings, for clarity, the size of certain feature is not drawn to scale as it may change.

### DETAILED DESCRIPTION

The present disclosure will be described below with reference to the attached drawings, and the attached drawings illustrate certain examples of the present disclosure. However, it should be understood that the present disclosure may be presented in many different ways and is not limited to the examples described below; in fact, the examples described below are intended to make the content of the present disclosure more complete and to fully explain the protection scope of the present disclosure to those skilled in the art. It should also be understood that the examples disclosed in the present disclosure may be combined in various ways so as to provide more additional examples.

It should be understood that the words in the Specification are only used to describe specific examples and are not intended to limit the present disclosure. Unless otherwise defined, all terms (including technical terms and scientific terms) used in the Specification have the meanings commonly understood by those skilled in the art. For brevity and/or clarity, well-known functions or structures may not be further described in detail.

The singular forms “a”, “an”, “the” and “this” used in the Specification all comprise plural forms unless clearly indicated. The words “comprise”, “contain” and “have” used in the Specification indicate the presence of the claimed features, but do not exclude the presence of one or more of other features. The word “and/or” used in the Specification comprises any or all combinations of one or more of the related listed items.

In the Specification, when it is described that an element is “on” another element, “attached” to another element, “connected” to another element, “coupled” with another element, or “in contact with” another element, etc., the element may be directly on another element, attached to another element, connected to another element, coupled with another element, or in contact with another element, or an intermediate element may be present.

In the Specification, the terms “first”, “second”, “third”, etc. are only used for convenience of description and are not intended for limitation. Any technical features represented by “first”, “second”, “third”, etc. are interchangeable.

In the Specification, terms expressing spatial relations such as “upper”, “lower”, “front”, “rear”, “top”, and “bottom” may describe the relation between one feature and another feature in the attached drawings. It should be understood that, in addition to the positions shown in the attached drawings, the words expressing spatial relations further comprise different positions of a device in use or operation. For example, when a device in the attached drawings is turned upside down, the features originally described as being “below” other features now can be described as being “above” the other features”. The apparatus may also be oriented in other ways (rotated 90 degrees or in other orientations), and the relative spatial relationships will be interpreted accordingly in those cases.

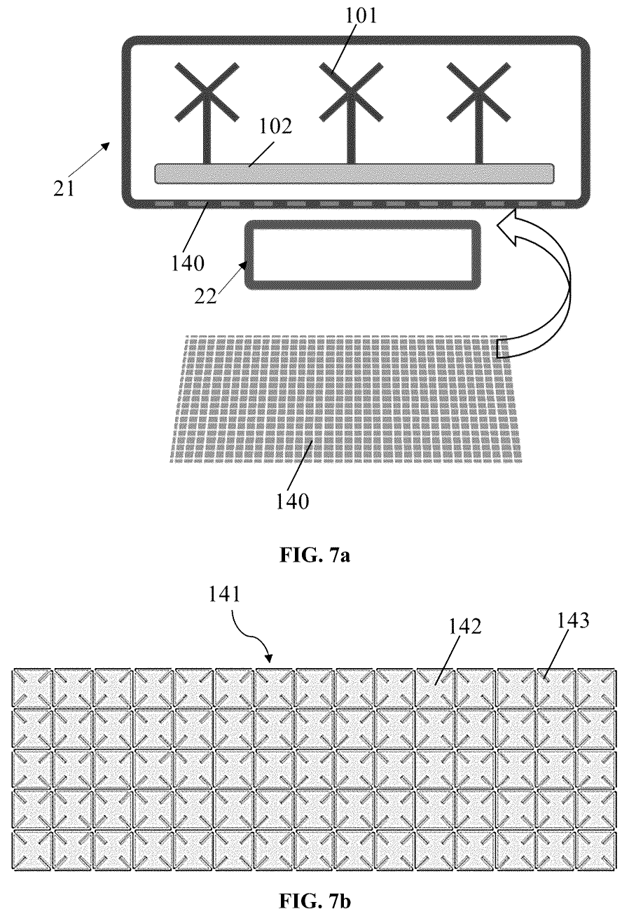

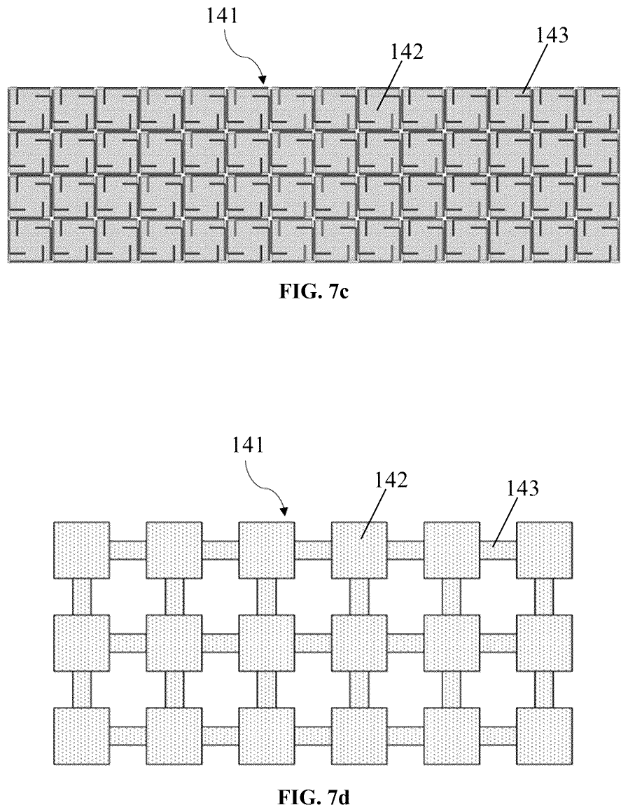

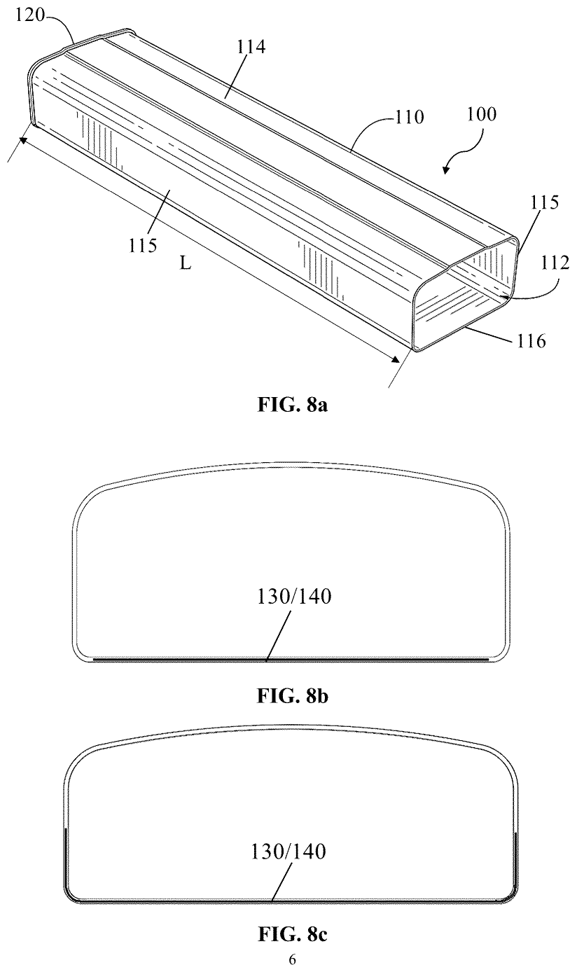

With reference to FIG. 6 to FIG. 8c, an antenna radome 100 according to some embodiments of the present disclosure is shown. Referring to FIG. 8a, the antenna radome 100 may comprise a body 110 that is in a generally elongated shape. The body 110 may extend along a longitudinal direction L and have an interior space 112 that penetrates through the body 110 along the longitudinal direction L. A reflector 102 of the base station antenna is mounted within the interior space 112 (as shown in FIGS. 6 and 7a). A radiating element 101 (as shown in FIGS. 6 and 7a) is mounted on a front side of the reflector 102 (the radiating element may, for example, be mounted directly on the reflector 102 or on a feed board printed circuit board that is mounted on the reflector 102). Additional components, not shown, are also typically housed in the interior space 112. End covers 120 (only one of which is shown in the figures) may be mounted on both ends of the body 110 to enclose the interior space 112 of the antenna radome 100.

The cross-section of the body 110 of the antenna radome 100 in a plane perpendicular to the longitudinal direction L may have different shapes, such as a generally rectangular shape, an oval shape, a generally rectangular shape with rounded shorter sides, a circular shape, or other suitable shapes. In the examples shown in FIGS. 6-8c, the body 110 of the antenna radome 100 has a cross-section that is generally rectangular. In these examples, as shown in FIG. 8a, the body 110 of the antenna radome 110 may comprise a front portion 114, a back portion 116 opposite the front portion 114, and two side portions 115 extending between the front portion 114 and the back portion 116. When mounted within the antenna radome 110, the radiating element 101 of the base station antenna faces a front portion 114 of the antenna radome 110.

In some embodiments, the body 110 of the antenna radome 100 may have an integral (monolithic) structure. In other examples, the body 110 of the antenna radome 100 may be formed by assembling a plurality of separate components.

In the examples according to the present disclosure, at least a portion of the body 110 of the antenna radome 100 is integrated with a PIM guard structure or an FSS structure (For example, a PIM guard structure or an FSS structure is integrated within at least a portion of a wall of the body 110). The at least a portion may be a portion of the body 110 that is behind the radiating element 101 and the reflector 102.

As shown in FIG. 6, in some embodiments, a PIM guard structure 130 may be integrated into or onto at least a portion of the body 110 of the antenna radome 100. The PIM guard structure 130 may be configured to partly shield the base station antenna from PIM distortion generated at an external PIM source. In the example shown in FIG. 6, the PIM guard structure 130 is integrated into the back portion 116 of the body 110 of the antenna radome 100, and respective sections 117 of the two side portions 115 that are adjacent the back portion 116. In this example, a length Ls of each section 117 does not exceed a distance H from the back portion 116 to a position of the radiating element 101 (e.g., the PIM guard structure 130 may extend in both side portions 115 to the position of the reflector 102, but not exceed the position of the reflector 102) to avoid the PIM guard structure 130 from affecting RF performance of the base station antenna. In other examples, the PIM guard structure 130 may only be integrated into the back portion 116 of the body 110 of the antenna radome 100, as shown in FIG. 8b.

In particular, the conductive fiber structure may be formed by weaving carbon fiber materials. Carbon fiber materials not only have metal-like conductive properties, but also have good electromagnetic shielding properties. Carbon fiber materials have good absorption, reflectance, and scattering, are capable of absorbing and converting part of PIM noise energy into thermal energy, and are capable of reflecting other parts of the PIM noise energy to avoid affecting PIM-sensitive devices. In addition, the carbon fiber materials also have high strength. Thus, integration of a conductive fiber structure formed by weaving the carbon fiber materials into the antenna radome is capable of achieving good PIM interference performance of the antenna radome, and is also capable of improving the reliability of the base station antenna.

In some embodiments, the PIM guard structure 130 may also comprise a PIM guard layer formed of carbon particles, short carbon fibers, or metal powder. Carbon particles, short carbon fibers, or metal powder may be mixed in suitable resin to form the PIM guard layer.

In some embodiments, the PIM guard structure 130 may be configured to comprise one or more layers as desired.

In some embodiments, as shown in FIG. 7a, at least a portion of the body 110 of the antenna radome 100 may be integrated with an FSS structure 140. The FSS structure 140 is configured to allow a signal in a first frequency range (e.g., a high frequency electromagnetic wave in a 2.3-4.2 GHz frequency band or a portion thereof) to pass through, and not allow a signal in a second frequency range that is different from the first frequency range (e.g., a low frequency electromagnetic wave in a range of 696 MHz to 960 MHz or a portion thereof). In the example shown in FIG. 7a, the at least a portion of the antenna radome 100 integrated with the FSS structure 140 may comprise the back portion 116 of the body 110 of the antenna radome 100. In other examples, as shown in FIG. 8c, the at least a portion of the antenna radome 100 integrated with the FSS structure 140 may comprise the back portion 116 of the body 110 of the antenna radome 100, and respective sections 117 of the two side portions 115 that are adjacent the back portion 116.

The FSS structure 140 may be composed of a plurality of pattern cells 141 arranged periodically along transverse and longitudinal directions of the base station antenna. Each pattern cell may have a predetermined pattern and may comprise a capacitive structure 142 and an inductive structure 143. The capacitive structure 142 and the inductive structure 143 may be configured to electrically couple in series with each other. However, the present disclosure is not limited to this, the capacitive structure and the inductive structure may also be configured to electrically couple in parallel with each other, or electrically connect with each other in other more complex ways. In addition, each of the pattern cells may be electrically connected to each other through the inductive structure. For example, the inductive structure in each pattern cell may be electrically connected to the inductive structure of an adjacent pattern cell.

The resonance frequency of the FSS structure 140 may be configured by selecting or designing the pattern and size of the capacitive structure and the inductive structure of each pattern cell, as well as the spacing and configuration of the pattern cells, such that electromagnetic waves within a predetermined frequency range are capable of passing through the FSS structure.

FIGS. 7b-7d schematically illustrate a variety of FSS structures 140 having different pattern cells. However, the FSS structure may have a pattern cell that is different from the pattern cells shown in FIGS. 7b-7d, which will not be repeated here.

In some embodiments, the FSS structure 140 may be configured to comprise one or more layers as desired.

In some embodiments, as shown in FIG. 7a, the antenna radome 100 integrated with the FSS structure 140 can be used in an integrated base station antenna that comprises a passive antenna module 21 and an active antenna module 22 mounted at the back of the passive antenna module 21. The antenna radome 100 may be an antenna radome of the passive antenna module 21. The FSS structure 140 in the antenna radome 100 is configured to allow a signal of the active antenna module 22 mounted at the back of the passive antenna module21 to be transmitted forwardly through the passive antenna module 21 and to block a signal of the passive antenna module 21 from being transmitted backwardly.

In other embodiments, the antenna radome 100 integrated with the FSS structure 140 may be used in any suitable base station antenna. For example, the antenna radome 100 integrated with the FSS structure 140 may be used in a separate passive antenna, in a separate active antenna, or in an integrated base station antenna comprising the passive antenna module and the active antenna module.

In embodiments according to the present disclosure, firstly, the PIM guard structure 130 or the FSS structure 140 is integrated into the antenna radome to avoid the separate fixation and installation of the PIM guard structure 130 or the FSS structure 140, thereby saving material costs (e.g., the costs of fasteners, supporting pieces, tape, glue, etc.) and labor costs (e.g., avoiding additional installation steps). Secondly, by integrating the PIM guard structure 130 or the FSS structure 140 in the antenna radome, the interior space of the antenna radome and the arrangement of parts of the base station antenna within the antenna radome are not affected, so there is no need to redesign the existing base station antenna but rather replace the antenna radome of the existing base station antenna. Thirdly, by integrating the PIM guard structure 130 or the FSS structure 140 in the antenna radome, the risk of possible crumpling, flaking, or bubbling of the PIM guard structure 130 or the FSS structure 140 is avoided, and adverse effects of the temperature or weather on the PIM guard structure 130 or the FSS structure 140 may be reduced. Therefore, the base station antenna employing the antenna radome 100 of the present disclosure is more reliable. Finally, the base station antenna using the antenna radome 100 of the present disclosure has a lighter weight due to the fact that there is no need of using other materials (e.g., the cost of fasteners, supporting pieces, tape, glue, etc.).

Next, methods of manufacturing the antenna radome 100 according to the present disclosure will be described in detail.

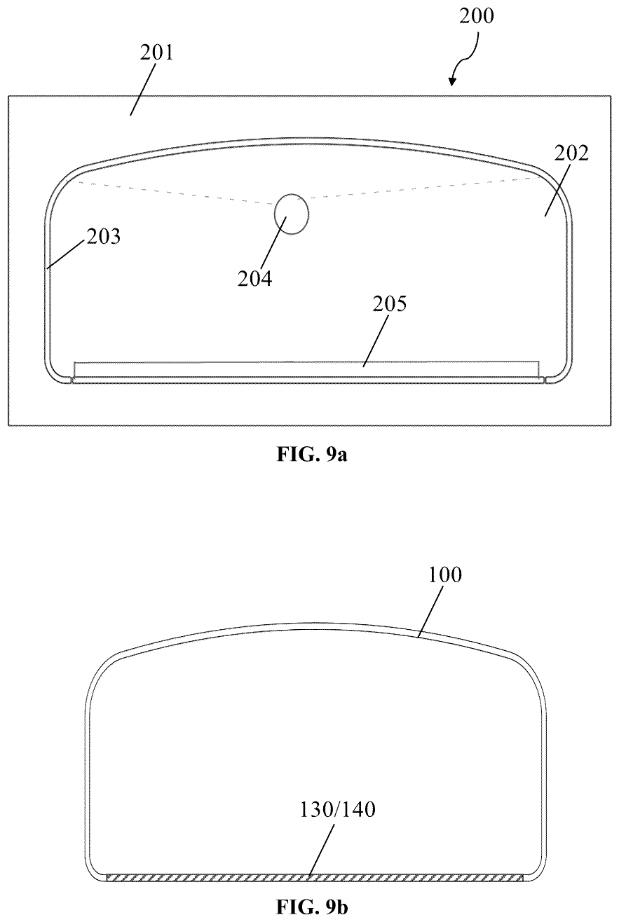

Referring to FIGS. 9a-9b, in some embodiments according to the present disclosure, the antenna radome 100 may be formed by an extrusion process using an extrusion device 200. The extrusion device 200 may comprise a forming mold 201 having a cavity and a core 202 positioned in the cavity of the forming mold 201. A gap 203 exists between the forming mold 201 and the core 202. The gap 203 may have a cross-section substantially corresponding to a cross-section of the antenna radome 100 to be formed. The antenna radome 100 may be formed by supplying an appropriate material to different portions of the gap 203 and curing and extrusion them.

In some embodiments, the extrusion device 200 may comprise a first opening 204 for supplying a first material 121′ (e.g., glass fibers or plastic) for forming the antenna radome 100 and a second opening 205 for supplying a second material 122′ (e.g., a metal film or anti-static (ESD) film 131, metal grid structure 132, printed circuit board 133, conductive fiber structure 134, or a PIM guard layer formed of carbon particles, short carbon fibers, metal particles) for forming a PIM guard structure or FSS structure. The first material 121′ for forming the antenna radome 100 and the second material 122′ for forming the PIM guard structure or FSS structure can be supplied to the extrusion device 200 via the first opening 204 and the second opening 205 respectively to integrally form the antenna radome 100 integrated with the PIM guard structure 130 or FSS structure 140 according to the present disclosure (as shown in FIG. 9b).

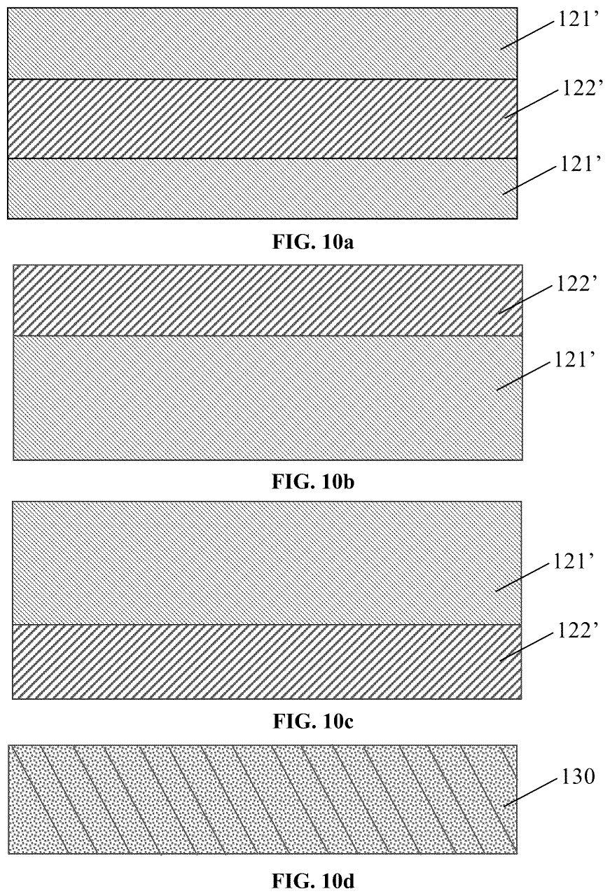

In some embodiments, the antenna radome 100 may be formed of glass fibers, i.e.: the first material 121′ used for forming the antenna radome 100 is glass fibers. The glass fibers may comprise two or more layers. In one example, as shown in FIG. 10a, in the process of forming a portion of the antenna radome 100 integrated with the PIM guard structure or FSS structure by using the extrusion device, an intermediate layer of at least a portion of the glass fiber may be replaced with the second material for forming the PIM guard structure or FSS structure, thereby integrating the PIM guard structure or the FSS structure into the portion of the antenna radome 100. In another example, as shown in FIG. 10b, in the process of forming a portion of the antenna radome 100 integrated with the PIM guard structure or FSS structure by using the extrusion device, an inner layer of at least a portion of the glass fiber may be replaced with the second material for forming the PIM guard structure or FSS structure (i.e.: a layer facing the interior space 112 of the antenna radome 100), such that the PIM guard structure or FSS structure is integrated into the portion of the antenna radome 100. In yet another example, as shown in FIG. 10c, in the process of forming a portion of the antenna radome 100 integrated with the PIM guard structure or FSS structure by using the extrusion device, an outer layer of at least a portion of the glass fiber may be replaced with the second material for forming the PIM guard structure or FSS structure (i.e.: a layer back to the interior space 112 of the antenna radome 100), such that the PIM guard structure or FSS structure is integrated into the portion of the antenna radome 100. In other examples, before the extrusion device is used to form the antenna radome 100, the intermediate layer, the inner layer, or the outer layer of the at least a portion of the glass fibers may be replaced with the second material for forming the PIM guard structure or FSS structure to form a composite layer, and then the composite layer is supplied to the extrusion device 200 via the second opening 205 to make the antenna radome 100. In this example, the step of replacing the glass fibers may comprise: manually laying up the second material for forming the PIM guard structure or FSS structure.

In some embodiments, as shown in FIG. 10d and as previously described, the PIM guard structure 130 may also comprise a PIM guard layer formed of carbon particles, short carbon fibers, or metal powder. In this example, regardless of whether the antenna radome 100 is formed of glass fibers or plastic, resin mixed with carbon particles, short carbon fibers, or metal powder may be used as a second material to form a PIM guard structure or FSS structure, and the second material may be supplied to the extrusion device 200 via the second opening 205 in the extrusion process to make the antenna radome 100.

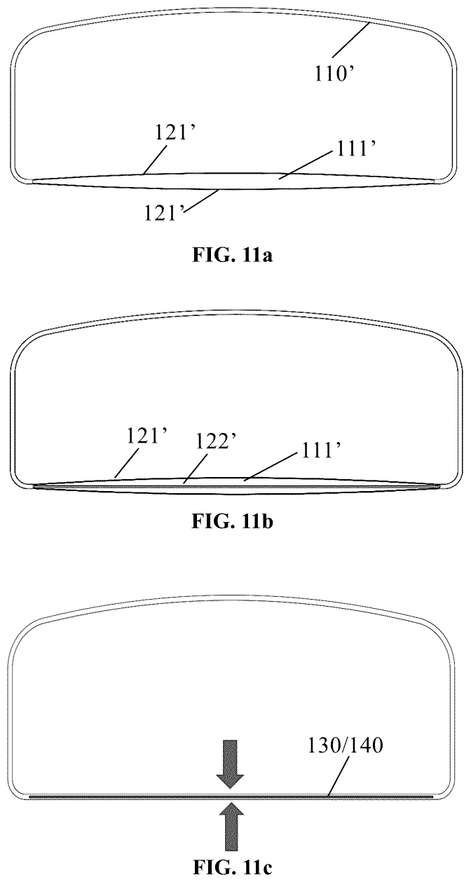

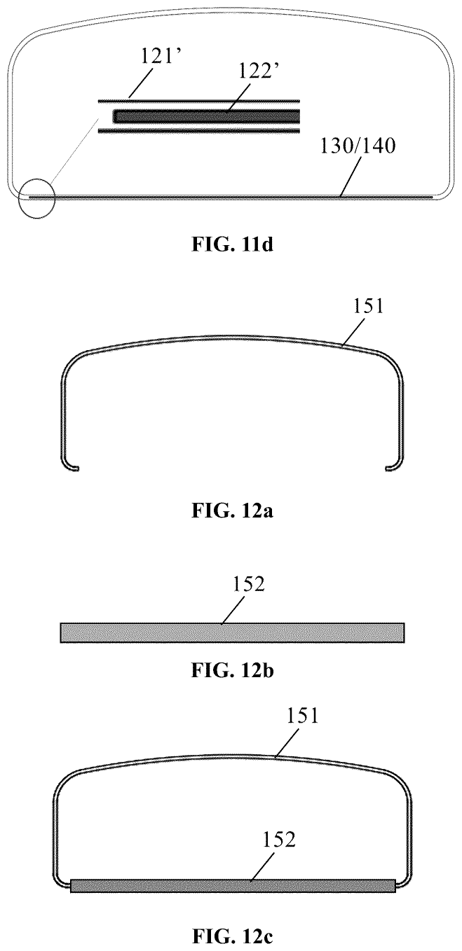

Referring to FIGS. 11a-11d, a method of making an antenna radome 100 according to another example of the present disclosure will be described.

In this example, firstly, as shown in FIG. 11a, the first material 121′ may be supplied to the extrusion device to extrude an initial body 110′ of the antenna radome, and the initial body 110′ may comprise a cavity structure 111′ formed of the first material 121′ and used for containing the PIM guard structure 130 or FSS structure 140. Secondly, the second material 122′ for forming the PIM guard structure or the FSS structure is arranged within the cavity structure 111′ in an appropriate manner (e.g., in a layup manner or other suitable manners). Finally, the cavity structure 111′ is extruded inwardly from both sides of the cavity structure 111′ at a predetermined temperature and pressure (e.g., high temperature and high pressure), such that the first material 121′ and the second material 122′ are bonded together to form the integrated PIM guard structure 130 or FSS structure 140. FIG. 11d is a partial enlarged view of the ultimately formed PIM guard structure 130 or FSS structure 140, where the second material 122′ can be seen sandwiched between two layers of the first material 121′.

In this example, the extrusion device may be an improved extrusion device 200, wherein the extrusion device 200 is improved such that the gap 203 has a cross-section substantially corresponding to a cross-section of the antenna radome 100 to be formed, and such that the initial body 110′ of the extruded antenna radome 100 comprises a cavity structure 111′.

In this example, the second material 122′ may be at least one of a metal film or an anti-static (ESD) film 131, a metal grid structure 132, a printed circuit board 133, a conductive fiber structure 134, or a PIM guard layer formed of carbon particles, short carbon fibers, and metal particles, as mentioned above. The first material 121′ may be one of glass fibers and plastic, preferably plastic.

Referring to FIGS. 12a-12c, a method of making an antenna radome 100 according to still another example of the present disclosure will be described.

In this example, the antenna radome 100 may first be formed as two or more separate portions. For example, as shown in FIGS. 12a and 12b, the antenna radome 100 may first be formed to comprise a first portion 151 and a second portion 152. The first portion 151 may be a body portion formed of a first material that may be formed by extrusion and may have a cross-section in, for example, a generally U-shaped or other shapes. The second portion 152 may be a portion comprising a PIM guard structure 130 or FSS structure 140. For the second portion 152, the intermediate layer, the inner layer, or the outer layer of the glass fibers may first be replaced with a second material for forming the PIM guard structure or FSS structure as shown in FIGS. 10a-10c, and then it is formed by extrusion or other suitable processes. The second portion 152 may also be formed of resin mixed with carbon particles, short carbon fibers, or metal powder as shown in FIG. 10d through extrusion or other suitable processes.

After the two or more separate components are formed, the two or more separate components may be fixed together in an appropriate manner (e.g., bonding, mechanical connection, conformal connection, etc.), thereby forming the antenna radome 100. Compared with the antenna radome formed through an extrusion process as shown in FIGS. 9a-9b, the method shown in FIGS. 12a-12c has a lower cost and is more suitable for vacuum shaping, as the relatively simpler extrusion device may be used and a portion comprising the PIM guard structure 130 or FSS structure 140 may be more easily formed.

The antenna radomes 100 made according to the methods discussed herein may have the structure as shown in FIGS. 8a-8c, and its cross-section may have the same or different shape as the cross-section as shown in FIGS. 8a-8c. When the cross-section of the antenna radome 100 is generally rectangular, the PIM guard structure or FSS structure may be integrated in a back portion of the antenna radome, or may be integrated in the back portion of the antenna radome and respective sections of the two side portions that are adjacent the back portion.

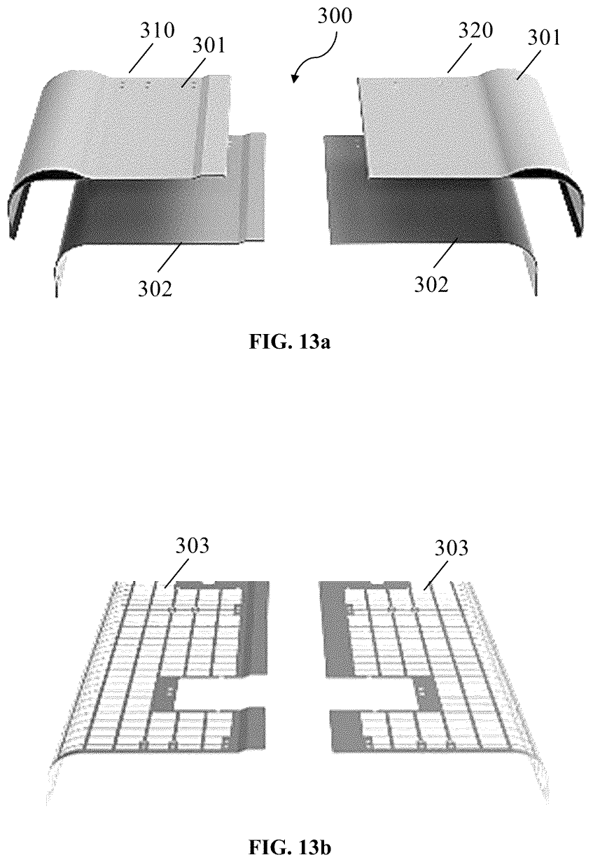

Additionally, the methods according to the present disclosure may be used not only to make the antenna radome 100 integrated with the PIM guard structure or FSS structure, but also to make other components. As shown in FIGS. 13a-13b, there is currently a PIM guard assembly 300 for an existing antenna radome. The PIM guard assembly 300 may be configured to cover the back of an existing antenna radome to reduce interference from external PIM sources. The PIM guard assembly 300 may comprise a first portion 310 and a second portion 320. The first portion 310 and the second portion 320 may extend along a longitudinal direction L of the antenna radome by a length that is substantially equal to a length of the antenna radome. The first portion 310 and the second portion 320 may be connected (e.g., snapped) to each other to cover the back of the entire antenna radome.

In the existing PIM guard assembly 300, each of the first portion 310 and the second portion 320 comprises an upper cover portion 301, a lower cover portion 302, and a PIM guard portion 303 arranged between the upper cover portion 301 and the lower cover portion 302. The upper cover portion 301, the lower cover portion 302, and the PIM guard portion 303 are fixed together with a connecting member (e.g., a plastic fastener). The existing PIM guard assembly 300 not only contains more parts, but also brings additional material costs and labor costs for their assembly.

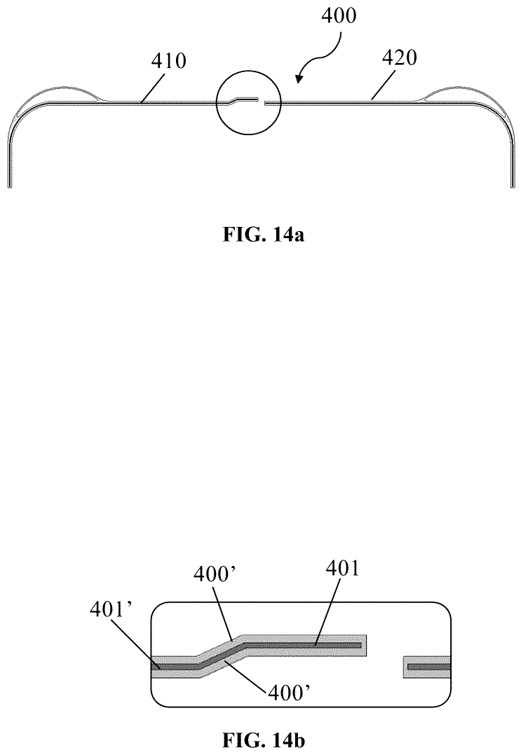

In one example according to the present disclosure, as shown in FIGS. 14a and 14b, the PIM guard assembly 400 integrated with the PIM guard portion 401 may be made using a method according to the present disclosure (e.g., the method as shown in FIGS. 10a-10d, or the method according to FIGS. 11a-11d). The PIM guard assembly 400 may comprise a first portion 410 and a second portion 420, wherein each of the first portion 410 and the second portion 420 is integrated with a PIM guard portion 401. The first portion 410 and the second portion 420 may extend along a longitudinal direction L of the antenna radome by a length that is substantially equal to a length of the antenna radome. The first portion 410 and the second portion 420 may be snapped together to cover the back of the entire antenna radome.

In some embodiments, the first portion and the second portion of the PIM guard assembly may be formed of a first material, while the PIM guard portion may be formed of a second material. The first material may comprise one of glass fibers and plastic. The second material may be selected from at least one of: a metal film or an anti-static film; a metal grid structure; a printed circuit board; a conductive fiber structure; and a PIM guard layer formed of carbon particles, short carbon fibers, or metal powder. In some embodiments, the first portion and the second portion of the entire PIM guard assembly may be formed of carbon particles, short carbon fibers, or metal powder mixed in resin.

When the PIM guard assembly 400 integrated with the PIM guard portion 401 is made using the methods as shown in FIGS. 10a-10d, the extrusion device 200 may be improved such that the gap 203 between the forming mold 201 and the core 202 has a cross-section substantially corresponding to a cross-section of the first portion 410 and/or the second portion 420 of the PIM guard assembly 400 to be formed. The first material 400′ for forming the first portion and the second portion of the PIM guard assembly 400 and the second material 401′ for forming the PIM guard portion can be supplied to the extrusion device 200 in an appropriate arrangement (e.g., the second material 401′ is placed on an inner side or an outer side of the first material 400′, or sandwiched between the first material 400′) to extrude at least one of the first portion and the second portion of the PIM guard assembly 400. In some embodiments, only the second material 401′ (e.g., resin mixed with carbon particles, short carbon fibers, or metal powder) that forms the PIM guard portion may be supplied to the extrusion device 200 to extrude at least one of the first portion and the second portion of the PIM guard assembly 400.

When the PIM guard assembly 400 integrated with the PIM guard portion 401 is made using the method as shown in FIGS. 11a-11d, the extrusion device 200 may be improved such that the gap 203 between the forming mold 201 and the core 202 has a cross-section substantially corresponding to a cross-section of the first portion 410 and/or the second portion 420 of the PIM guard assembly 400 to be formed, and such that the initial body of the first portion 410 and/or the second portion 420 of the extruded PIM guard 400 comprises a cavity structure. The first material 400′ for forming the first portion and the second portion of the PIM guard assembly 400 may first be supplied to the improved extrusion device 200 to form an initial body of the at least one of the first portion 410 and the second portion 420 of the PIM guard 400 that comprises the cavity structure. A second material for forming the PIM guard portion 501 is then arranged within the cavity structure of the initial body in an appropriate manner (e.g., in a layup manner or other suitable manners). Finally, the cavity structure is extruded inwardly from both sides of the cavity structure at a predetermined temperature and pressure (e.g., high temperature and high pressure) such that the first material and the second material are jointed to each other to form the PIM guard assembly 400.

Compared with an existing PIM guard assembly 300, the PIM guard assembly 400 according to the present disclosure has not only a smaller number of components (only has an integrated first portion 410 and an integrated second portion 420), but also fewer mounting steps, thereby shortening the installation time and reducing material and labor costs. Additionally, the PIM guard assembly 400 according to the present disclosure may have a lighter weight. Compared with an existing PIM guard assembly 300, the weight of the PIM guard assembly 400 may be reduced by 30%.

Exemplary examples according to the present disclosure have been described above with reference to the attached drawings. However, those of ordinary skill in the art should understand that various changes and modifications can be made to the exemplary examples of the present disclosure without departing from the gist and scope of the present disclosure. All changes and modifications are comprised in the protection scope of the present disclosure defined by the claims. The present disclosure is defined by the attached claims, and equivalents of these claims are also comprised.

1. A method of making an antenna radome for a base station antenna, wherein the antenna radome comprises a body generally in an elongated shape, the body extending in a longitudinal direction and comprising an interior space penetrating through the body along the longitudinal direction, wherein at least a portion of the body is integrated with a PIM guard structure or FSS structure, wherein the method comprises:
providing an extrusion device, wherein the extrusion device comprises a forming mold having a cavity and a core positioned in the cavity of the forming mold, a gap exists between the forming mold and the core, and the gap has a cross-section substantially corresponding to a cross-section of the antenna radome to be formed; and
supplying a first material and a second material to the extrusion device via different openings respectively to integrally form the antenna radome, wherein the first material is used for forming the antenna radome, and the second material is used for forming the PIM guard structure or FSS structure.

2. The method according to claim 1, wherein the first material comprises glass fibers or plastic, and the second material comprises resin mixed with carbon particles, short carbon fibers, or metal powder.

3. The method according to claim 1, wherein the first material is a glass fiber comprising two or more layers, and the second material comprises a metal film or an anti-static film, a metal grid structure, a printed circuit board, or a conductive fiber structure,
wherein the method comprises:
replacing an inner layer, an outer layer, or an intermediate layer of at least a portion of the glass fiber with the second material in the process of forming the antenna radome with the extrusion device.

4. The method according to claim 1, wherein the first material is a glass fiber comprising two or more layers, and the second material comprises a metal film or an anti-static film, a metal grid structure, a printed circuit board, or a conductive fiber structure,
wherein the method comprises:
first replacing the intermediate layer, the inner layer, or the outer layer of the at least a portion of the glass fiber with the second material to form a composite layer before forming the antenna radome with the extrusion device, and then supplying the composite layer to the extrusion device.

5. The method according to claim 4, wherein the step of replacing the intermediate layer, the inner layer, or the outer layer of the at least a portion of the glass fiber with the second material to form a composite layer comprises: manually laying up the second material.

6. A method of making an antenna radome for a base station antenna, wherein the antenna radome comprises a body generally in an elongated shape, the body extending in a longitudinal direction and comprising an interior space penetrating through the body along the longitudinal direction, wherein at least a portion of the body is integrated with a PIM guard structure or FSS structure, wherein the method comprises:
supplying a first material to an extrusion device to extrude an initial body of the antenna radome, the initial body including a cavity structure formed of the first material;
arranging a second material for forming the PIM guard structure or FSS structure within the cavity structure; and
extruding the cavity structure inwardly from both sides of the cavity structure at a predetermined temperature and pressure, such that the first material and the second material are bound to one another.

7. The method according to claim 6, wherein the first material comprises one of glass fibers and plastic, and the second material is selected from at least one of: a metal film or an anti-static film; a metal grid structure; a printed circuit board; a conductive fiber structure; and a PIM guard layer formed of carbon particles, short carbon fibers, or metal powder.

8. A method of making an antenna radome for a base station antenna, wherein the antenna radome comprises a body generally in an elongated shape, the body extending in a longitudinal direction and comprising an interior space penetrating through the body along the longitudinal direction, wherein at least a portion of the body is integrated with a PIM guard structure or FSS structure, wherein the method comprises:
supplying a first material to an extrusion device to extrude a first portion of the antenna radome;
forming a second portion comprising a PIM guard structure or FSS structure; and
fixing the first portion and the second portion together.

9. The method according to claim 8, wherein the first portion has a cross-section that is generally U-shaped.

10. The method according to claim 8, wherein the first material is a glass fiber comprising two or more layers, the PIM guard structure or FSS structure is formed of a second material, and the second material comprises a metal film or an anti-static film, a metal grid structure, a printed circuit board, or a conductive fiber structure, wherein the second portion is formed by replacing an inner layer, an outer layer, or an intermediate layer of at least a portion of the glass fiber with the second material.

11. The method according to claim 8, wherein the first material comprises one of glass fibers and plastic, the PIM guard structure or FSS structure is formed from a second material, the second material comprises resin mixed with carbon particles, short carbon fibers, or metal powder, and wherein the second portion is formed by extrusion of the second material.

12. The method according to claim 8, wherein the first portion and the second portion are fixed together by bonding, mechanical connection, or conformal connection.

13. An antenna radome for an base station antenna, comprising a body generally in an elongated shape, the body extending in a longitudinal direction and comprising an interior space penetrating through the body along the longitudinal direction, wherein a PIM guard structure or FSS structure is integrated within at least a portion of a wall of the body, the PIM guard structure is configured to prevent the base station antenna from interfering by an external PIM source, and the FSS structure is configured to allow signals in a first frequency range to pass through and not allow signals in a second frequency range different from the first frequency range to pass through.

14. The antenna radome according to claim 13, wherein the body of the antenna radome has a cross-section that is generally rectangular, elliptical, playground track-shaped, or circular in a plane perpendicular to the longitudinal direction, wherein the at least a portion of the body is a portion of the body that is behind a reflector of the base station antenna.

15. The antenna radome according to claim 13, wherein the body of the antenna radome has a cross-section that is generally rectangular in a plane perpendicular to the longitudinal direction, wherein the body of the antenna radome comprises a front portion, a back portion opposite the front portion, and two side portions extending between the front portion and the back portion, and wherein the at least a portion of the body comprises the back portion.

16. The antenna radome according to claim 15, wherein the at least a portion of the body further comprises corresponding sections of the two side portions that are adjacent the back portion, and wherein a length of each section does not exceed a distance from the back portion to a position where radiating elements of the base station antenna are positioned.

17. The antenna radome according to claim 13, wherein the antenna radome has an integral structure.

18. The antenna radome according to claim 13, wherein the antenna radome is formed by assembling a plurality of separate components, and wherein the PIM guard structure or FSS structure is integrated into one of the plurality of separate components.

19. The antenna radome according to claim 13, wherein the PIM guard structure or FSS structure comprises one or more layers.

20. The antenna radome according to claim 13, wherein the PIM guard structure is selected from at least one of: a metal film or an anti-static film; a metal grid structure; a printed circuit board; a conductive fiber structure; and a PIM guard layer formed of carbon particles, short carbon fibers, or metal powder.

21-29. (canceled)
